(19) United States
(12) Patent Application Publication
(10) Pub. No.: US 2005/0116191 A1
(43) Pub. Date: Jun. 2, 2005

(54) Pressure and flow regulating valve for a gas or liquid

(76) Inventor: Claes Karlebratt, Saffle (SE)

Correspondence Address: OSTROLENK FABER GERB & SOFFEN, 1180 AVENUE OF THE AMERICAS, NEW YORK, NY, 100368403, US

(21) Appl. No.: 10/513,155

(22) PCT Filed: Apr. 29, 2003
(86) PCT No.: PCT/SE03/00693

(30) Foreign Application Priority Data
Apr. 30, 2002 (SE) 0201311-8

(51) Int. Cl. F16K 39/00

(52) U.S. Cl. 251/282

(57) ABSTRACT

The invention relates to a pressure and flow regulating valve for a gas or liquid comprising a valve housing (1) having one in the same against a seating (2) regulating piston (3). The piston (3) consists partly of an opening- or slot-provided, drilled cylindrical cage portion (4), situated close to the seating (2) or its seating portion (11), through said cage portion (4) the gas or liquid is intended to flow during small openings and high pressure drops for regulating the flow against said seating (2) and a profiled portion (6), situated beneath said cage portion (4), for regulating the flow besides through the cage portion (4) also between the seating (2) and said profiled portion (6) during larger openings, increased flow and during a low pressure drop.

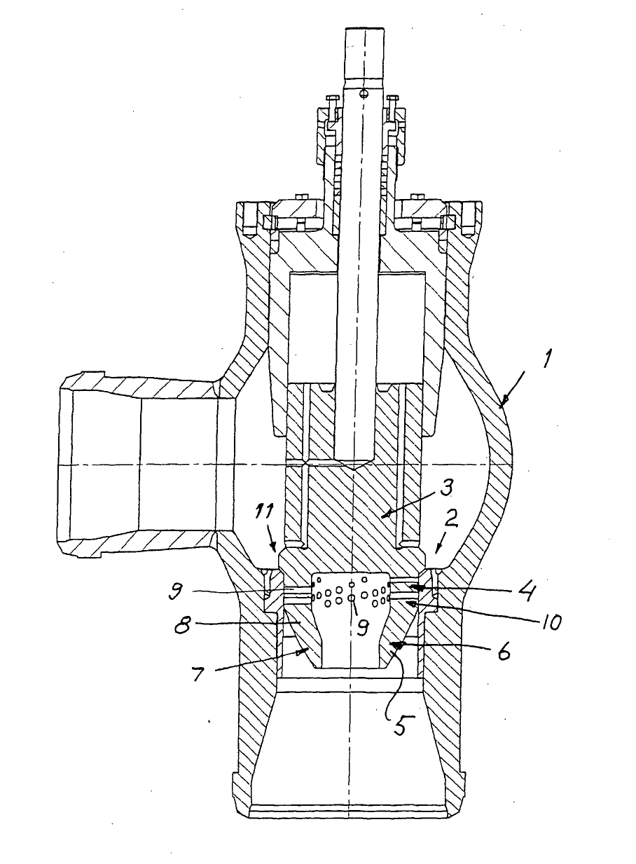

The present invention refers to a pressure and flow regulating valve for a gas or liquid and said valve comprises a valve housing having a piston, which is adjustable against a seating and said valve is able to regulate both large pressure drops and small flows as well as low pressure drops and high flows.

Normally, valves intended for regulating high pressure drops use to be provided with a piston consisting of a cage provided with openings or the like, which regulate against a seating. Those valves, which are intended for regulating low pressure drops and high flows usually comprise a contour piston for the regulation in itself, which takes place by that the outer contour of the piston regulates against the seating.

The object of the present invention is to provide a valve of the type mentioned above, which combines these two piston types in one and the same valve. During small openings and high pressure drops the liquid or the gas is thus supplied through the drilled cage of the valve piston and when the flow increases and the pressure drop is low the flow is regulated of the outer contour of the same valve piston. The valve in itself is built up in a traditional way having a valve housing with a piston situated in the same, which regulates against a seating. The characterizing features of the invention are set forth in the claims enclosed.

Thanks to the invention a valve has now been provided, which in an excellent way fulfils its purposes at the same time as it also is easy and cheap to manufacture. Thanks to the invention one and the same valve can now pressure- and flow-regulate a gas or a liquid during both large pressure drops and small flows and also during low pressure drops and high flows, which has not been possible before. By this structure two piston types are combined in one and the same piston. In other words in previously known solutions two different types of valves have been needed to be used, but by aid of the present invention one and same valve can be used for two purposes, viz. to pressure- and flow-regulate both during large pressure drops and small flows and also during low pressure drops and high flows.

The invention is described closer below by aid of a preferable embodiment example in view of the drawing enclosed, which shows a schematic cross-section view of a valve having a piston according to the present invention and where the piston is in its closing position against the valve seating formed in the valve housing.

As can be seen from the drawing a valve according to the invention is illustrated, which is intended for pressure- and flow-regulating of a gas or a liquid and said valve comprises a valve housing 1 having a piston 3 regulating in the same against a seating 2. The piston 3 consists partly of closest said seating 2 or its seating portion 11 an opening- or slot-provided cage 4, through which the gas or liquid is supplied or flows during small openings and high pressure drops in regulating the flow against the seating 2 and a profiled portion 6 situated beneath the cage portion 4 for regulating the gas or liquid, i.e. the flow, besides through the cage portion 3 also between the seating 2 and said profiled portion 6 during larger openings, increased flow and a low pressure drop. The opening- or slot-provided cage 4 is delimited laterally and in a direction against the seating 2 during closed valve and an outer valve 5, the thickness and form of which constitutes “a contour piston” or said profiled portion 6.

The free end 7 of the profiled portion 6 has a shape of a cap 8 and having an outer contour diverging from its free end 7. The openings or drillings 9 of the cage 4 extend through the outer wall 5 of the piston valve or cage immediately inside the diverging valve portion of the profiled portion 6, where the piston 3 comprises a cylinder-formed portion 10, which ends in the seating portion 11 of the piston 3 for co-operation with the seating 2 of the valve housing 1.

The valve according to the invention functions in the following way. As can be seen from the figure a piston 3 is here illustrated in its closed position having the piston 3 with its seating portion 11 contacting against the seating 2. As soon as the piston 3 is moved somewhat in a direction upwards the incoming flow first comes in contact with the drillings 9, through which a small flow having a high pressure drop flows or is led through the drilled cage or cage portion 4. When the flow increases during the movement of the piston 3 in a direction upwards and the pressure drop is low the flow is regulated through the valve by the outer contour of the piston 3 and more exactly both through the cage portion 4 and between the seating 2 and the profiled portion 6.

The drilled, cylindrical cage portion 4 is acting alone from the sealing edge or seating 2 of the valve to an opening position of the valve from one case to another defined position. When the valve works in a still more opened valve position the drilled cylindrical portion 4 and the profiled portion are in function, while the main part of the flow of the valve is passing the valve through the profiled portion of the valve piston.

1. A pressure and slow regulating valve for a gas or liquid comprising a valve housing (1) having one in the same against a seating (2) regulating piston (3), characterized in that the piston (3) consists of partly an opening- or slot-provided, drilled cylindrical cage portion (4), situated close to the seating (2) or its seating portion (11), through said cage portion (4) the gas or liquid is intended to flow during small openings and high pressure drops for regulating the flow against said seating (2) and a profiled portion (6), situated beneath said cage portion (4), for regulating the flow besides through the cage portion (4) also between the seating (2) and said profiled portion (6) during larger openings, increased flow and during a low pressure drop.

2. A valve according to claim 1, characterized in that the opening- or slot-provided cage portion (4) is laterally delimited and in a direction towards said seating (2) of an outer wall (5), the thickness and form of which constitutes the profiled portion (6).

3. A valve according to claim 2, characterized in that the profiled portion (3) is cap-formed in constituting said cage (4) and hating an outer contour diverging from its free end (7).

4. A valve according to any of the preceding claims, characterized in that the openings or slots of the cage portion (4) have the form of drillings (9), which extend through the piston wall (5) over a cylinder-formed portion (10) of said piston (3) for co-operation with the valve housing (1) and its seating (2), said portion (10) is delimited by the seating portion (11) of the piston (3) and the profiled portion (6).
